(19) United States
(12) Patent Application Publication
(10) Pub. No.: US 2022/0084152 A1
(43) Pub. Date: Mar. 17, 2022

(54) SYSTEMS, METHODS AND APPARATUS FOR OBTAINING AND PRESERVING EVIDENCE DATA CORRESPONDING TO AN INCIDENT

(71) Applicant: Thin Blue Defend, LLC, Augusta, GA (US)

(72) Inventor: James Douglas PARKER, JR., Appling, GA (US)

(73) Assignee: Thin Blue Defend, LLC

(21) Appl. No.: 17/469,105

(22) Filed: Sep. 8, 2021

Related U.S. Application Data
(60) Provisional application No. 63/077,343, filed on Sep. 11, 2020.

(51) Int. Cl. G06Q 50/26; G06Q 10/10

(52) U.S. Cl. CPC G06Q 50/26; G06Q 10/1093

(57) ABSTRACT

Methods of operating a wireless communication device are provided. Operations corresponding to such methods include, prior to use corresponding to incident, providing, via a user interface in the wireless communication device, a prompt for a user to provide law enforcement officer data, providing, via the user interface, a prompt for the user to provide equipment data that corresponds to equipment that is expected to be used by a law enforcement officer, providing, via the user interface, a prompt for the user to provide multiple types of incident data. The multiple types of incident data include scene data, utilized equipment data corresponding to equipment that was deployed corresponding to the incident, suspect action data, suspect physical characteristic data, building/structure data, additional equipment data, incident scene crowd data, officer credential data, and/or legal obligation data. Operations include receiving, via the user interface, at least two of the types of incident data.

### CROSS REFERENCE TO RELATED APPLICATIONS

This application claims domestic priority to U.S. Provisional Application No. 63/077,343 titled “SYSTEMS, METHODS AND APPARATUS FOR OBTAINING AND PRESERVING EVIDENCE DATA CORRESPONDING TO AN INCIDENT,” filed Sep. 11, 2020, the disclosure of which is hereby incorporated in its entirety by reference.

### BACKGROUND

Incidents including the use of force by law enforcement officers continue to be reported, in some cases selectively, by the mainstream media and news. Such reporting may result in an increase for transparency and objective data collection. With the rise of smartphones and video recording, incidents and/or portions thereof are being documented and displayed nearly instantly to millions of viewers. Police managers are often unable to prove a statement until hours or days after an incident, by which time many citizens may have already drawn conclusions regarding the incident. In some circumstances, police officers may be subjected to criminal allegations and/or charges and/or civil liability based on insufficient and/or incorrect information.

While increased body camera adoption rates may provide some contemporaneous information, several issues have arisen with the use of body cameras. Further, body cameras used on a wide scale may be expensive. Additionally, issues with functionality (e.g., cameras may fall off and/or fail to record) have been reported, many during to occurrence of such incidents. Such cases may require management and/or officers to self-report, sometimes well after the incident has occurred. Such approaches may rely entirely on the individual and may have gaps in detail based on the inconsistencies corresponding to post incident self-reporting. Cameras may be one dimensional and thus may not show the entire field of view and may be absent the officer's perception.

Accordingly, a need exists for improved systems that involve gathering evidence and taking notes corresponding to an incident.

### SUMMARY

Disclosures herein are directed to methods of operating a wireless communication device. Such methods include, prior to use corresponding to incident, providing, via a user interface in the wireless communication device, a prompt for a user to provide law enforcement officer data, wherein law enforcement officer data comprises a jurisdiction state. Operations include, in responsive to receiving law enforcement officer data, displaying audio and/or video regulations corresponding to the jurisdiction state and providing, via the user interface, a prompt for the user to provide equipment data that corresponds to equipment that is expected to be used by a law enforcement officer. Some embodiments include receiving, via a user interface, the equipment data and, responsive to receiving input that incident has occurred, receiving inputs from user that affirm safety conditions are satisfied. Some embodiments include providing, via the user interface, a prompt for the user to provide a plurality of types of incident data. In some embodiments, the plurality of types of incident data comprises at least two of scene data, utilized equipment data corresponding to equipment that was deployed corresponding to the incident, suspect action data, suspect physical characteristic data, building/structure data, additional equipment data, incident scene crowd data, officer credential data, and/or legal obligation data. Operations include receiving, via the user interface, at least two of the plurality of types of incident data.

Some embodiments include generating a calendar entry that corresponds to planned activities that are related to the incident.

In some embodiments, the equipment data includes images and/or a weight of each equipment item to be carried by the user.

In some embodiments, the equipment data corresponds to at least one of a weapon, a holster, ammunition, a personal restraint, a non-lethal weapon, a recording device, flashlight, communication equipment, protective clothing, and personal protective equipment.

In some embodiments, before providing a prompt for incident related data, the methods further include providing, via the user interface, a prompt to provide input indicating custodial status of the wireless communication device and receiving, via the user interface, an input indicating the custodial status of wireless communication device. Some embodiments that, before providing a prompt for incident related data, the methods further include providing, via the user interface, a prompt for the user to provide an input that disclaims usage limitations and receiving, via the user interface, an input indicating the usage limitations are acknowledged.

In some embodiments, the safety conditions include at least one of an input that confirms that threats are contained, an input that confirms that aid has been rendered to everyone and/or that medical personnel are rendering aid, an input that confirms that the user is approved by medical personnel to continue and/or an input that confirms that a suspect is restrained safely.

Some embodiments include providing, via the user interface, a prompt for the user to secure incident related documentation. Some embodiments further include receiving, via the user interface, the incident related documentation and/or an input that confirms that the incident related documentation is secured.

Some embodiments herein are directed to a computer program product, comprising a tangible computer readable storage medium comprising computer readable program code embodied in the medium that when executed by at least one processor causes the at least one processor to perform operations disclosed herein.

Some embodiments are directed to a wireless communication device that includes a processing circuit, a user interface and a memory that includes machine-readable code that, when executed, cause the processing circuit to perform operations including, prior to use corresponding to incident, providing, via a user interface in the wireless communication device, a prompt for a user to provide law enforcement officer data, wherein law enforcement officer data comprises a jurisdiction state, in responsive to receiving law enforcement officer data, displaying audio and/or video regulations corresponding to the jurisdiction state, and providing, via the user interface, a prompt for the user to provide equipment data that corresponds to equipment that is expected to be used by a law enforcement officer. Operations include receiving, via a user interface, the equipment data, responsive to receiving input that incident has occurred, receiving inputs from user that affirm safety conditions are satisfied, and providing, via the user interface, a prompt for the user to provide a plurality of types of incident data, wherein the plurality of types of incident data comprises at least two of scene data, utilized equipment data corresponding to equipment that was deployed corresponding to the incident, suspect action data, suspect physical characteristic data, building/structure data, additional equipment data, incident scene crowd data, officer credential data, and/or legal obligation data. Some embodiments include receiving, via the user interface, at least two of the plurality of types of incident data. Some embodiments include one-touch GPS location and one-touch weather data capture.

### BRIEF DESCRIPTION OF THE DRAWINGS

The accompanying drawings, which are included to provide a further understanding of the present disclosure and are incorporated in and constitute a part of this application, illustrate certain embodiment(s).

FIG. 1 is a block diagram illustrating a system that may be used to provide evidence preservation and note taking according to some embodiments of the present disclosure.

FIG. 2 is a block diagram of an electronic device that may be an example of an evidence collection, note taking and preservation node according to some embodiments of the present disclosure.

FIG. 3 is a block diagram of a wireless communication device and methods of operation according to some embodiments of the present disclosure.

FIG. 4 is a schematic diagram illustrating a wireless communication device according to some embodiments of the present disclosure.

FIG. 5 is a block diagram illustrating a method for evidence collection, note taking and evidence preservation according to some embodiments of the present disclosure.

### DETAILED DESCRIPTION

Embodiments of the present disclosure will be described more fully hereinafter with reference to the accompanying drawings. Other embodiments may take many different forms and should not be construed as limited to the embodiments set forth herein. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein. As used herein, the term “and/or” includes any and all combinations of one or more of the associated listed items.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages such as DART and JAVA script. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and sub-combination of these embodiments. Accordingly, all embodiments can be combined in any way and/or combination, and the present specification, including the drawings, shall support claims to any such combination or sub-combination.

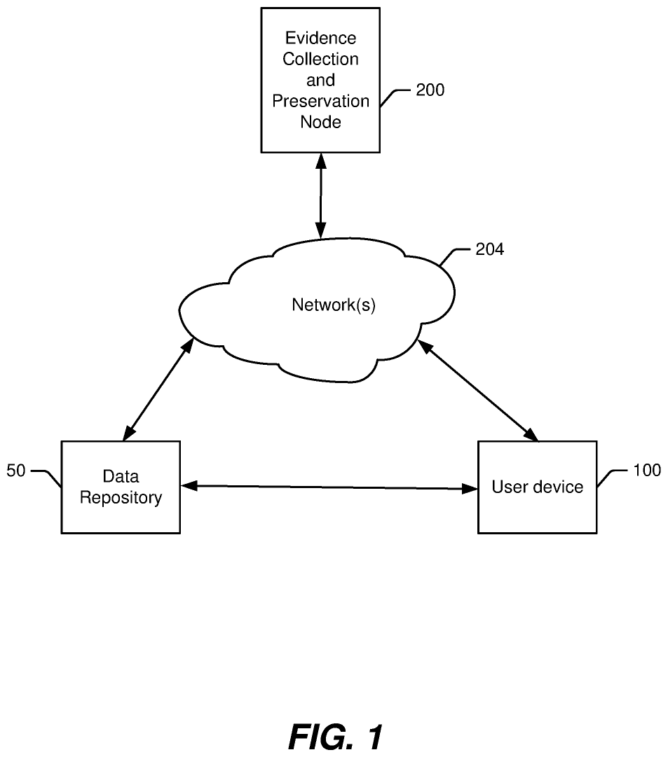

Reference is now made to FIG. 1, which is a block diagram illustrating a system that may be used to provide evidence preservation according to some embodiments of the present disclosure. Some embodiments provide that systems and/or operations disclosed herein may include an evidence collection and preservation node 200 that may be communicatively coupled to one or more data repositories 50 and/or one or more user devices 100 via one or more wired and/or wireless communication and/or data networks 204. In some embodiments, the data repository 50 and the user device 100 may be directly communicatively coupled via a near field communication protocol.

In some embodiments, the evidence collection and preservation node 200 may include a dedicated computer that includes a running instance of an application that is capable of receiving and transmitting communications to the one or more data repositories and/or one or more user devices 100. Some embodiments provide that the evidence collection and preservation node 200 may further include instances and/or operations corresponding to a file server, a database server, an application server and/or a web server. In some embodiments, the evidence collection and preservation node 200 includes a stationary or fixed location processing device that receives power via a wired power connection to a facility and/or building power source. Some embodiments provide that the evidence collection and preservation node 200 transmits and/or receives data via a wired data connection. In some embodiments, the evidence collection and preservation node 200 may be provided on a mobile processing device that includes an on-board power source and that transmits and/or receives data using a wireless and/or wired data connection. As disclosed herein, the evidence collection and preservation node 200 may provide a persistent store of data, maps, user inputs, user device operational data, and the like.

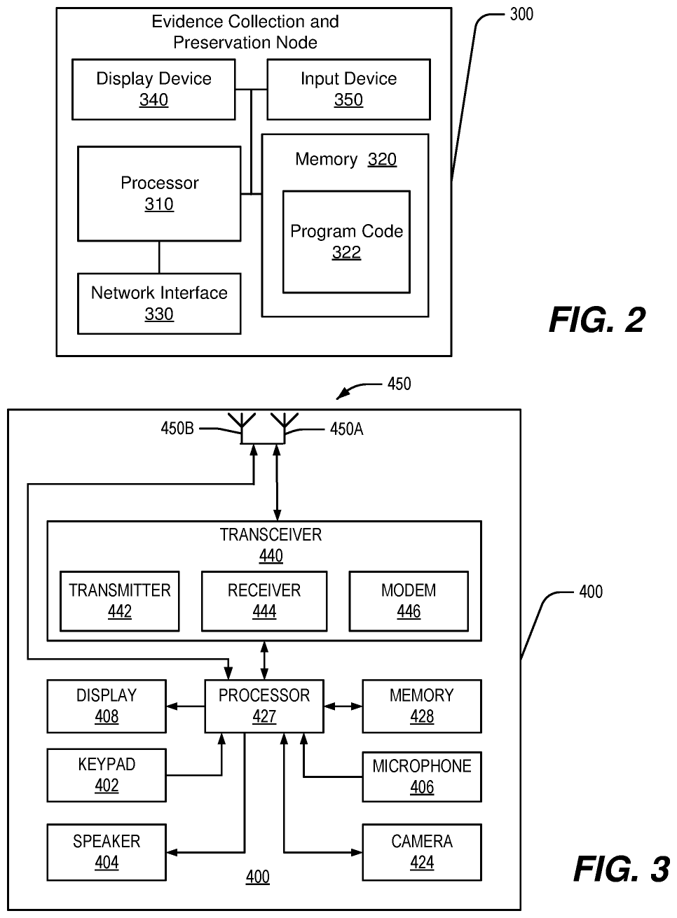

Reference is now made to FIG. 2, which is a block diagram of an electronic device that may be an example of an evidence collection and preservation node according to some embodiments of the present disclosure. Reference is now made to FIG. 3, which is a block diagram of an electronic device that may be an example of the evidence collection and preservation node 200 according to some embodiments of the present invention. The electronic device 300 includes one or more network interfaces 330, processor circuitry (“processor”) 310, and memory 320 containing program code 322. The processor 310 may include one or more data processing circuits, such as a general purpose and/or special purpose processor (e.g., microprocessor and/or digital signal processor) that may be collocated or distributed across one or more networks. The processor 310 is configured to execute program code 322 in the memory 320, described below as a computer readable storage medium, to perform some or all of the operations and methods that are described above for one or more of the embodiments. The memory 320 is representative of the one or more memory devices containing the software and data used for facilitating operations for managing the robot in accordance with some embodiments of the present invention. The memory 320 may include, but is not limited to, the following types of devices: cache, ROM, PROM, EPROM, EEPROM, flash, SRAM, and DRAM.

The electronic device 300 may also include a display device 340 (which may display a drag-and-drop user interface) and/or an input device 350, such as a keyboard, touch sensitive display device, mouse, pointer, etc. The network interface 330 can be configured to communicate through one or more networks with any associated available resource server(s) and/or data repositories.

Although FIG. 2 illustrates hardware/software architectures that may be used in collecting and preserving evidence according to some embodiments described herein, it will be understood that the present invention is not limited to such a configuration but is intended to encompass any configuration capable of carrying out operations described herein.

FIG. 3 is a block diagram of a wireless communication device and methods of operation according to some embodiments of the present invention. The wireless communication device 400 is configured to transmit and/or receive wireless signals over multiple wireless communication interfaces. For example, a wireless communication device 400 according to some embodiments can include a cellular communication module, a Bluetooth module, an infrared communication module, a global positioning system (GPS) module, a WLAN module, and/or other types of communication modules.

With a cellular communication module, the wireless communication device 400 can communicate using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, Universal Mobile Telecommunications System (UMTS), and 3GPP LTE (3rd Generation Partnership Project Long Term Evolution).

With a Bluetooth or infrared module, the wireless communication device 400 can communicate via an ad-hoc network using a direct wireless interface. With a WLAN module, the wireless communication device 400 can communicate through a WLAN router using a communication protocol that may include, but is not limited to, 802.11a, 802.11b, 802.11e, 802.11g, and/or 802.11i.

In particular, the wireless communication device 400 includes a display 408, such as a liquid crystal display (LCD) and/or an organic light emitting diode (OLED) display. The wireless communication device 400 may optionally include a keypad 102 or other user input mechanism on the front housing 410 of the device 400. In some embodiments, the display 408 may be provided with touch screen capability to replace and/or supplement the keypad 402.

The wireless communication device 400 may include a microphone 406 and an earphone/speaker 404. The front housing 410 may be designed to form an acoustic seal to the user's ear when the earphone/speaker 404 is placed against the user's head.

The keypad 402, display 408, microphone 406, speaker 404 and camera 424 may be coupled to a processor 427, such as a microprocessor or microcontroller, which may be configured to control operations of the wireless communication device 400. The wireless communication device 400 may further include a transceiver 440 and a memory 428 coupled to the processor 427. Other electronic circuitry, such as a WLAN communication interface, a Bluetooth interface, a GPS interface, a digital signal processor, etc., may also be included in the electronic circuitry of the device 400.

The memory 428 may be a general purpose memory that is used to store both program instructions for the processor 427 as well as data, such as audio data, video data, configuration data, and/or other data that may be accessed and/or used by the processor 427. The memory 428 may include a nonvolatile read/write memory, a read-only memory and/or a volatile read/write memory. In particular, the memory 428 may include a read-only memory in which basic operating system instructions are stored, a non-volatile read/write memory in which re-usable data, such as configuration information, directory information, and other information may be stored, as well as a volatile read/write memory, in which short-term instructions and/or temporary data may be stored.

The transceiver 440 typically includes a transmitter circuit 442, a receiver circuit 444, and a modem 446, which cooperate to transmit and receive radio frequency signals to remote transceivers via an antenna array 450. The radio frequency signals transmitted between the device 400 and the remote transceivers may comprise both traffic and control signals (e.g., paging signals/messages for incoming calls), which are used to establish and maintain communication with another party or destination. More particularly, the transceiver 440, in operational cooperation with the processor 427, may be configured for communication according to multiple radio access technologies. The radio access technologies may include, but are not limited to, WLAN (e.g., 802.11), WiMAX (Worldwide Interoperability for Microwave Access), 3GPP LTE (3rd Generation Partnership Project Long Term Evolution), Universal Mobile Telecommunications System (UMTS), Global Standard for Mobile (GSM) communication, General Packet Radio Service (GPRS), enhanced data rates for GSM evolution (EDGE), DCS, PDC, PCS, code division multiple access (CDMA), wideband-CDMA, and/or CDMA2000. Other radio access technologies and/or frequency bands can also be used in embodiments according to the invention.

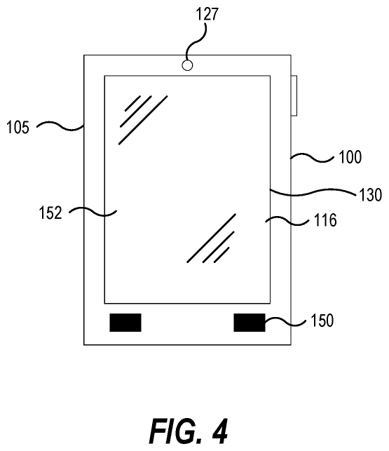

Brief reference is now made to FIG. 4, which is a schematic diagram illustrating a wireless communication device according to some embodiments of the present disclosure. In some embodiments, a user device 100 comprises a personal device, such as a desktop computer, a laptop computer, a mobile device, a tablet computer or computing device, a personal digital assistant (PDA), or other portable computing devices. In some embodiments, the user device 100 may be operable over a wireless network, such as part of a wireless system. In such embodiments, the user device 100 may be a hand-held device, a mobile device or any other suitable wireless device that enables a user to collect and preserve evidence corresponding to an incident and/or event occurring at a variety of different locations and/or environments. It should be appreciated that a user device 100 as disclosed herein may be a device that has obtained approval from a regulatory agency or a device that has not obtained approval from a regulatory agency.

For example, referring to FIG. 4, a user device 100 may be implemented as a handheld device including a compact housing 105 on which is mounted a touchscreen display device 116 including a digitizer 152. As described in greater detail with respect to FIG. 3 above, one or more pressure sensitive input devices 130 may be included for providing functionality for embodiments described herein. A camera 127 may be provided in a front face of the housing 105 and/or in the rear face of the housing 105. The housing 105 may include one or more speakers 150. In some embodiments, the user device 100 may include one or more power sources such as one or more rechargeable batteries (not illustrated) that may provide power to the user device 100 when external power supplies are unavailable. In the user device 100, various input buttons may be implemented as soft buttons on the touchscreen display device 116 and/or pressure sensitive input device 130. In this embodiment, the pressure sensitive input device 130 is integrated into the touchscreen display device 116, but it should be understood that the pressure sensitive input device may also, or alternatively, be separate from the display device 116. Moreover, the user device 100 may omit certain features.

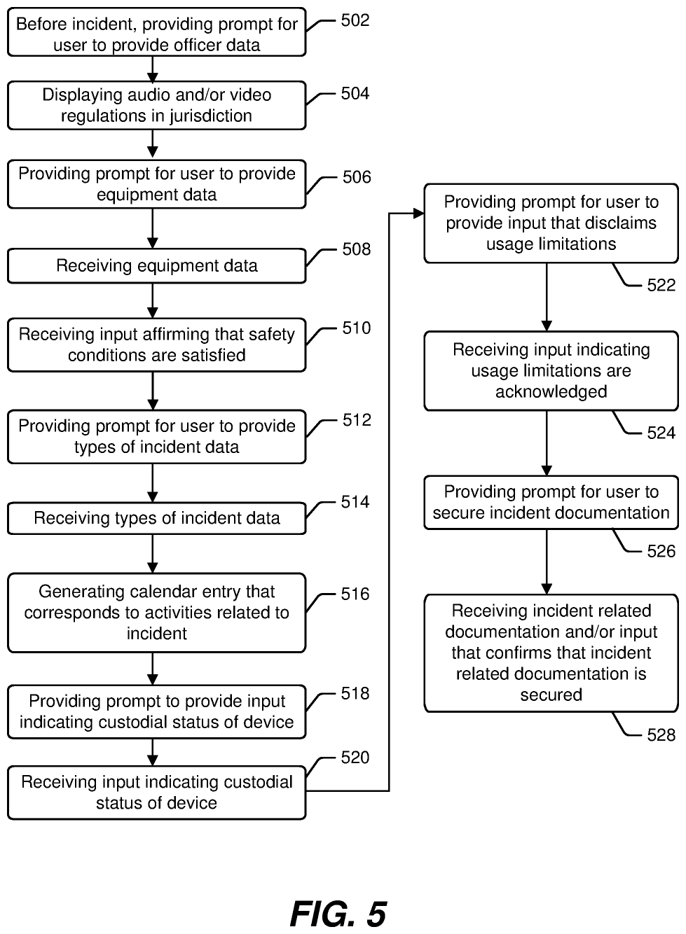

Reference is now made to FIG. 5, which is a block diagram illustrating methods for evidence collection and preservation according to some embodiments of the present disclosure. In some embodiments, the methods may be performed on a user device, such as a wireless communication device and/or an evidence collection and preservation node. For example, in some embodiments, operations and/or portions thereof may be performed at the evidence collection and preservation node.

In some embodiments, the user device includes a graphical user interface (GUI) that displays information to the user and that is configured to receive inputs from the user into the user device. In some embodiments, the GUI changes the information being displayed to the user based on inputs received from the user and/or from an external source. In some embodiments, the GUIO changes information being requested from the user based on inputs received from the user and/or from an external source.

Similarly, some embodiments provide that operations and/or portions thereof may be performed at the user device. In some embodiments, the user device and/or the evidence collection and preservation node 200 may transmit and/or receive data to and/or from a separate data repository. In some embodiments, once data is collected by the user device, such data may be transmitted to the evidence collection and preservation node and/or the data repository. Some embodiments provide that such data may be transmitted once complete and/or may be transmitted upon receipt thereof.

In some embodiments, officer data that is stored may be deidentified and/or encrypted. Some embodiments provide that no officer personal information is stored except for sex/gender, race and incident information such as suspect sex/gender, race, gang affiliation, weapons used and suspect status.

In some embodiments, systems and methods herein may include a web-based program that may be executed on the evidence collection, note taking and preservation node and that may be accessed by a user via a website that may be accessed by the user. Some embodiments provide that some or all of the input that is provided by the user may be received through the evidence collection, note taking and preservation node. Some embodiments provide that such input may be received using the website at a time after the incident. For example, a user may recall additional details that may be entered via the website. Other examples provide that the user information may be received using the web-site and may include pictures of issued equipment that may be uploaded from the user device, such as a camera and/or mobile telephone.

In some embodiments, the evidence collection, note taking and preservation node may include cloud-based resources for collecting and preserving evidence and the taking of notes. Some embodiments provide that the evidence collection, note taking and preservation node includes a web interface that allows the user to access and input data in the absence of the user device. For example, in some embodiments, data retained by the data repository may be used and/or accessed using the user device and/or the evidence collection, note taking and preservation node.

In some embodiments, methods and/or systems disclosed herein may include a web-based program that may receive data that is collected using a user device. In some embodiments, data corresponding to the user interface that is displayed on the user device is provided by the evidence collection, note taking and preservation node. For example, the evidence collection, note taking and preservation node transmits data corresponding to a screen that is displayed on the user device. In such embodiments, data input into the user device may be sent to the evidence collection, note taking and preservation node for analysis and/or storage.

Operations according to such methods may include, before use corresponding to incident, providing (502), via a user interface in the user device, a prompt for a user to provide law enforcement officer data. In some embodiments, the law enforcement officer data may include a jurisdiction corresponding to a state, county, or municipality.

For example, law enforcement officer data may include officer information including name, race, sex, date of birth, a listing of any physical limitations, such as vision correction, joint injuries, an agency name, a state/municipality, a badge number, a state controlling agency, and/or a state controlling agency telephone number, the officer's state controlling identifying number, an emergency contact including contact information, a state/national police organization attorney including contact information, a spouse/significant other, a supervisor, a chaplain/pastor, a peer counselor, and/or a HIPPA release, among others.

Although discussed herein in the context of the user being a law enforcement officer, embodiments herein are not so limited. For example, some embodiments provide that the user may include a legal representative, such as, an attorney. Further, in some embodiments, users may include private citizens that may defend themselves against attack from a potentially criminal element. For example, attorneys and private citizens may be faced with the need to defend themselves whether at home, in a work environment and/or in public.

Some embodiments provide that, in response to receiving law enforcement officer data, operations include displaying (504) audio and/or video regulations corresponding to one or more jurisdictions. For example, different jurisdictions may have different regulations regarding what evidence or note taking may be audio recorded and/or video recorded. In this manner, the user may access an audio/video feature of the user device in a manner that does violate state or local laws on the recording of another party. Some embodiments, operations include informing the user to advise anyone present that they are about to audio record a private conversation of themself.

Some embodiments include providing (506), via the user interface, a prompt for the user to provide equipment data that corresponds to equipment that is expected to be used by a law enforcement officer. Some embodiments provide that the equipment data is to be provided before any incident occurs. Equipment may include one or more weapons and the corresponding data may include make, model, caliber, serial number, whether the weapon was personal or issued, a picture of the weapon, weight, and last date of certification, among others.

In some embodiments, equipment may include a weapon holster. In such embodiments, equipment data may include a make, model, security level, whether the holster was personal or issued, one or more photographs of the holster and/or the weight, among others. Some embodiments provide that the user device includes the camera that may be accessed to provide this and other equipment data.

In some embodiments, equipment may include ammunition. In such embodiments, equipment data may include brand, caliber, type, quantity carried and configuration of carry. For example, equipment data may include how many rounds are carried in the weapon and how many rounds are carried in spare magazines and/or speed loaders. In the case in which the officer is carrying multiple rounds of ammunition, the user device may prompt the user to provide equipment data corresponding to additional equipment articles. Some embodiments provide that entering the caliber may be performed using a scroll function on the user interface of the user device.

In some embodiments, the equipment data may describe shotguns and shotgun rounds in a similar manner as other ammunition.

Additional magazine data may include type, capacity, how many rounds are loaded, whether the magazine is personally provided or issued, a photograph of the magazine and/or weight, among others. Some embodiments provide that each loaded magazine should be weighed, and the loaded weight be received by the user device.

Equipment may include personal restraints such as handcuffs and/or nylon zip tie restraints. Equipment data may include make, model, serial number, whether the equipment is personal or issued, a holder, and/or weight, among others.

Equipment may include non-lethal protective devices including tasers, stun guns, pepper spray, batons, remote restraint, such as, BOLA WRAP® and/or tear gas. Equipment data may include make, model, serial number, carrier, total weight, last date of certification, length, aftermarket attachments, whether issued or personal, concentration and/or whether delivered in a stream or a foam, among others. Regarding a taser, the equipment data may include whether one or both probes were in the suspect, whether probes were removed, who removed the probes, whether first aid was rendered, who rendered first aid, and/or what warnings were provided to the suspect prior to deployment of the taser, among others. In some embodiments, this data may be provided by engaging an audio interface, such as a microphone function and receiving the information in the form of a recorded statement.

Other equipment may be included, such as, a body cam, flashlight, handheld radio, ballistic vest, ballistic helmet, ballistic shield, and/or goggles, among others. Corresponding equipment data may include make, model, location mounted, whether personal or issued, weight, a photograph, serial number, carrier details, and/or issue date, among others.

Some embodiments provide a prompt for the user to provide equipment data that corresponds to equipment failures of CAD, mobile devices, such as mobile phones, and/or systems providing internet and/or GPS access. Systems such as, for example, Watchguard, and/or other types of cyber-security. The user may be prompted to provide information corresponding to other systems, such as, for example other radios and/or types thereof.

Equipment data may be received (508) using the user interface of the user device using touchscreen, providing audio descriptive data, providing video data, and/or by selecting from prepopulated menu items.

Operations may further include receiving an input from the user indicating that safety conditions are satisfied (510). For example, before a user can proceed with collecting and preserving evidence according to methods herein, multiple different inputs corresponding to safety are received. Inputs confirm that threat(s) at the scene have been stopped and/or contained, that aid to everyone has been rendered and/or professional emergency medical technicians are now on scene and have taken over life preserving measures, that the user is cleared by medical personnel, regardless of how minor an injury may be, and that, once contained, the suspect is not handcuffed behind the back while lying on the stomach, that no officer is on the suspect's back or blocking the airway, and that the legs are not restrained and drawn to the handcuffed hands. In response to receiving inputs that each of these conditions is satisfied, the user may proceed.

Such inputs may include public safety information. For example, the user may be prompted to provide information regarding whether they are injured, if they know of anyone that is injured, if their weapon was discharged, what the direction of discharge was, if there are any suspects at large, descriptions and direction of travel of at-large suspects, How long ago did the suspects flee, what crimes the suspects are suspected of committing, are they believed to be armed, is there any evidence that needs to be preserved, the location(s) of any evidence, were any witnesses observed, and/or the location of witnesses, among others.

Inputs may further include the application of de-escalation techniques. Such information may be gathers corresponding to each suspect. For example, the user may be prompted to information regarding whether verbal contact or other connection was made with a suspect in which the suspect acknowledged your presence and/or voice. The user may be prompted to provide information regarding the suspects responses including visual contact, making eye contact, changing and/or stopping actions, and/or talking/yelling in response. The user may be prompted to provide information regarding whether the suspect ignored commands and/or continued their actions. In some embodiments, if a conversation did begin, what active listening techniques were employed including repeating, rewording, summarizing and/or paraphrasing among others.

Operations include providing (512) a prompt for the user to provide multiple types of incident data. Types of incident data include one or more of scene data, utilized equipment data corresponding to equipment that was deployed corresponding to the incident, suspect action data, suspect physical characteristic data, building/structure data, additional equipment data, incident scene crowd data, officer credential data, and/or legal obligation data.

Operations further include receiving (514) different types of incident data via a camera, microphone, and/or touchscreen, among other ways included in the user interface. For example, details (notes) and evidence may be gathered by scrolling through a variety of prompts and/or questions presented in an ordered collection of screens that are defined in the user interface and displayed thereby. Requested details include scene documentation, lighting, such as streetlights, surrounding residences, businesses, and vehicles. Lighting may be provided by and/or data may be received from security cameras nearby, residences, and/or businesses, among others.

Scene data may include weather conditions at the time of the incident. In some embodiments, a link to a weather data repository may allow the user to enter a nearby address and capture a screenshot of the reported weather conditions. Some embodiments provide that weather conditions may be characterized using provided selections, such as light, moderate and heavy for rain, snow, ice, fog, sun, wind or other condition. Data may be entered that describes whether the weather has changed since the incident and may identify whether the incident and/or report gathering time, specific nighttime conditions such as no moon, some moon, and/or full moon.

For indoor scenes, lighting conditions such as daylight, artificial light, no lighting may be received and temperature may be estimated and/or measured and received.

Inputs corresponding to officer personal injuries may be received. Non-visible injuries may be received based on recording the descriptions thereof. Aches/pains may be described regarding exact location. Other injury details may be received that correspond to nausea, dizziness, blurred vision, ringing in ears, etc. Visible injuries may be received via the camera on the user device.

A list of police equipment that was used in the incident may be received. Equipment data may include details corresponding to each firearm deployed and whether or not the weapon was fired or used. Examples of such weapons include firearms, tasers, batons, OC spray, etc.

Other equipment that was used includes handcuffs, which may include information regarding whether the handcuffs were used behind the back, in front, and/or whether they were double locked or not. Details regarding the deployment of flex-cuffs, OC spray, including whether aid was rendered may be received.

In some embodiments, equipment data may correspond to vehicles that were deployed at the incident. For example, data may include an operator identity and/or badge number for an operator of any of an armored personnel carrier, SWAT vehicle, bomb robot, robot, and/or a drone, among others.

Equipment data may include data corresponding to the deployment of a flash-bang or other explosive and/or manual entry devices. Such data may include an operator identity and/or a badge number, among others. Additionally, equipment data may correspond to equipment that was lost, damaged and/or that malfunctioned during the incident.

Other incident data may include the actions of suspects. Similar information may be sought for each suspect. Suspect data may correspond to offensive actions by suspect directed at me and may be characterized as one or more of: presented a defensive stance; used fists, arms, legs, feet; used nearby, available weapon, such as a rock, stick, metal object, sand, or bottle; used weapon brought by suspect, such as a knife, gun, brass knuckles, metal object; used vehicle access; and/or made verbal threats, among others.

Suspect data may correspond to offensive actions by suspect directed at other law enforcement and may be characterized as one or more of: presented a defensive stance; used fists, arms, legs, feet; used nearby, available weapon, such as a rock, stick, metal object, sand, or bottle; used weapon brought by suspect, such as a knife, gun, brass knuckles, metal object; used vehicle access; and/or made verbal threats, among others.

Suspect data may correspond to offensive actions by suspect directed at bystanders and may be characterized as one or more of: presented a defensive stance; used fists, arms, legs, feet; used nearby, available weapon, such as a rock, stick, metal object, sand, or bottle; used weapon brought by suspect, such as a knife, gun, brass knuckles, metal object; used vehicle access; and/or made verbal threats, among others.

Suspect data may correspond to offensive actions by suspect directed at hostages and may be characterized as one or more of: presented a defensive stance; used fists, arms, legs, feet; used nearby, available weapon, such as a rock, stick, metal object, sand, or bottle; used weapon brought by suspect, such as a knife, gun, brass knuckles, metal object; used vehicle access; and/or made verbal threats, among others.

Suspect data may correspond to a suspects access and/or attempted access to equipment and may be characterized as one or more of: grabbed at my firearm; grabbed at my taser; grabbed at my ASP baton; grabbed at my handcuffs; took my firearm; took my taser; took my ASP baton; took my handcuffs; used my firearm; used my taser; used my ASP baton; and/or used my handcuffs, among others.

Some embodiments provide that suspect data include crimes committed by the suspect including relevant code sections, including whether felony or misdemeanor. Victims of such crimes may be listed.

Suspect data may include suspect physical characteristics including, for example, height, build, weight, gender, race, age, citizenship status (U.S. non-U.S.), known gang affiliation, and/or drug usage at time of incident. Suspect data may include prior knowledge of suspect including: arrests, specify charges, if known; drug usage, type of drug(s); prior altercations with law enforcement; information provided by dispatch; information provided by witnesses; information provided by victim(s); information provided by other law enforcement officers; and/or prior encounter with suspect, among others. Suspect data may include suspect special skills, such as, martial arts, boxing, survival skills, prior military, and/or prison.

Suspect data may correspond to suspect weapons and may list each weapon produced, threatened, mentioned, and/or perceived and how they were utilized. Examples to confirm include a firearm, an edged weapon, a club, a bat, a baton, a rock, a brick, an improvised weapon, and/or an explosive device, among others. Suspect data may include how the weapon was used offensively.

Suspect data may include suspect's actions at different stages of the incident. For example, suspect actions may be determined upon LEO's presence, in response to LEO commands, after each use of force, at a fled scene event, and a whereabouts unknown condition. Suspect data may include an explanation regarding suspect actions prior to officer presence and/or during the officer's presence that may cause concern for any other party. A description of any level of resistance by suspect including any observations regarding drug usage, intoxication and/or mental issues.

Suspect data may include data corresponding to a suspect vehicle, including make, model and color, among others. An explanation of how the vehicle was used, including whether it was used offensively, the position of the suspect vehicle relative to the user and/or user vehicle, and/or a final resting place, among others, may be received. Information regarding sounds from the suspect vehicle, such as the horn blowing, doors opening/closing, and/or engine revving, among others, may be received. Information regarding suspect vehicle conditions such as headlights, leaking fuel or other substance, fire/smoke, and/or damage, among others, may be received. Identification and/or description of any objects thrown from the vehicle may be received.

Suspect data may include data corresponding to a suspect vessel/boat and/or personal watercraft (PWC), including make, model, color, and/or length, among others. An explanation of how the vessel was used, including whether it was used offensively, the position of the suspect vessel relative to the user and/or the user's vessel, and/or a final resting place, among others. Information regarding sounds from a suspect vessel, such as a horn and/or engine revving, among others, may be received. In some embodiments, information corresponding to vessel conditions including spotlights, running lights, leaking fuel or other substance, and/or fire/smoke damage, among others, may be received. Identification and/or description of any objects thrown from the vessel may be received.

Suspect data may include data corresponding to a suspect all-terrain vehicle (ATV), including make, model, and/or color, among others. An explanation of how the ATV is used, including whether it was used offensively, the position of suspect ATV to the user and/or the user's ATV/vehicle and/or a final resting place, among others.

Information regarding sounds from a suspect ATV, such as a horn and/or engine revving, among others, may be received. In some embodiments, information corresponding to ATV conditions including spotlights, running lights, leaking fuel or other substance, and/or fire/smoke damage, among others, may be received. Identification and/or description of any objects thrown from the ATV may be received.

Suspect data may include data corresponding to vehicle pursuit, including a list evasive actions initiated by driver, such as, sped up, erratic speed changes, erratic lane changes, endangering other drivers, swerving, and/or running off of the roadway, among others. Additional pursuit data may include officer knowledge of the pursuit path including dangers/concerns including a rural area, a desolate area, an end to a maintained road, a heavily populated area, a restricted area, a school zone, a subdivision, military zones, no-wake zones, shallow waters, obstructed waters, and/or beaches, among others. Yet further, data may include information regarding the speed for the particular roadway, the condition of the roadway, the surface type and/or condition of the roadway including whether the surface was dirt, gravel, paved, and/or the presence of surface abnormalities, such as potholes or the like.

Suspect data includes a suspect status which may include one or more of whereabouts unknown, fled the scene, arrested, deceased, attended by EMT, transported to hospital, and/or transported to detention center/jail, among others.

Suspect data may also include a list of any witnesses at the scene of the incident.

Incident data may include data corresponding to pursuit termination techniques that were used and/or attempted such as stationary roadblock, moving roadblock, channelization, tire deflation device, and/or a P.I.T. maneuver, among others.

Incident data may further include data corresponding to any obstructions and/or hinderances which caused extra hardships and/or cautious tactics or made it difficult to communicate. Examples include, visual hindrances such as sun in the face or dust, noises such as loud construction noises, traffic, music, and crowds, landscaping, i.e. trees, shrubs, soft ground, terrain i.e. ditches, hills, high grass, heavy foliage, creeks, streams, rivers, lakes, marsh, sand, steep approach, wet grass, wet clay, gravel, blacktop, concrete, natural/man-made/static hazards, drop offs, retaining wall, steep terrain, open holes, construction site, standing water, pool, pond, lake, stream, river, frozen water, dilapidated/unsafe structures, shed, barn, deck, dock, flooring, railings, stairs, and/or ladders, among others.

Additional hindrances may include those corresponding to residences and buildings. Hindrances inside buildings may include furniture, lighting, hazards with dilapidation of walls, floors and ceilings, obstructed views from doors, and/or curtains/barriers. Hindrances outside of buildings may include trees, shrubs, foliage, yard structures, decks, stairs, and/or sinkholes.

Scene data may further include data corresponding to distractions, such as crowd size, quantity, and locations, crowd compliance with commands, and/or visible or perceived weapons. Other distraction examples include sirens, construction noise, car alarms, emergency alarms like fire alarms, wind, car horns that are stuck on/constant and/or intermittent.

Other scene data may include distractions corresponding to animals, such as, type, number, location, barking, aggressiveness as well as other conditions such as fire, suspicious devices, and other vehicles, such as trucks, cars, tractor trailers, and/or boats, among others. Other hindrances may include those related to topography and/or elevation changes, among others.

Obstructions and/or hindrances may include an offender's speech including characterizations such as accented, foreign, slurred, unintelligible, and/or yelling, among others.

Other scene data may include data corresponding to the user's attire. For example, scene data may include how the user is dressed such as in a police uniform, is the user wearing a hat/cap, are sleeves long or short, is the user wearing a badge and if so, is it metal or embroidered, where is the badge worn, are there department patches and, if so, where are they located, the presence, type and location of a belt, gun holster, firearms, taser, extra magazines, handcuffs, ASP baton, OC spray, handheld radio, short or long pants, socks and shoes, plate carrier, ballistic helmet, goggles, a balaclava, and/or a ballistic shield, among others.

Scene data may correspond to the presence of a K-9. Data may include the name of the K-9, type of training (i.e., apprehension, narcotics, ordinance), K-9 certification date, a photo of the certification, handler certification, photo of handler certification, reason for apprehension on suspect stating the felony that was committed, and, if the suspect has dog related injuries, a photo of injuries after EMT cleans the injuries.

Other scene data may include the shift being worked, reporting time for that shift, actual reporting time that shift, reason for deviation, if any, end of shift, days of the week worked, off days, department designation for shift, list of officers working in user's precinct, squad, unit, and/or detail. Other scene data may include identification of officer working closest to you, supervisors on shift, rank, name and badge #. Scene data further includes data corresponding to the user role that may be selected from patrol officer, entry team, pursuit vehicle, and/or supervisor, among others.

Scene data may also include data corresponding to a riot situation. Riot data may include: crowd approximate numbers; how the crowd is dressed, such as clothing, backpacks, face-coverings, etc.; the presence of and/or type of weapons seen or perceived, such as, sticks, rocks, bottles, firearms, flags with points, and/or unknown liquids; the use of weapons including how weapons are used; the presence of specific emergency orders/laws enacted by government; crowd control measures utilized, such as street barriers (metal/wood), vehicles deployed, police, maintenance vehicles i.e. dump trucks, county/city vehicles, and/or police lines; whether tear gas was deployed, and if so, by whom; whether non-lethal force was deployed; commands given, list commands and frequency; response of crowd to commands; and/or a list any violations observed such as destroying property, burning property/buildings, and/or attacking officers/citizens, among others.

Scene data may further include data corresponding to the use of force by other offices. For example, data may include: whether the user observed another officer using force, if so, did you determine the force to be excessive; the officer's name; whether you advised to office to discontinue to force; the nature of the excessive force; actions taken to stop the officer using the excessive force; whether the excessive force was reported to a supervisor; the supervisor's name; and/or how the supervisor was notified, among others.

Some embodiments include providing a prompt for post-incident investigation data. Some embodiments provide that post-incident investigation data includes: whether there was an attempt to interview the user by the investigative agency at the scene, if so, by whom; the name of Investigator; a photo of the investigator's business card; the investigator's phone numbers; whether the user was advised of Miranda Rights; was the user advised that this is a criminal investigation and that they are not compelled by their agency to talk about the incident; what was said to the investigator; was there a formal interview by the investigative agency; if so, by whom; was a member of the user's agency present during the interview; if there were any visual aids used in the interview; did the user request to view any video prior to making a statement; a response from the investigator; whether the user refused an opportunity to review any video prior to making a statement; did the user prepare a written statement; a photograph of each page of the written statement; was the statement recorded; by whom; did the user record the interview; if yes, identity of the device, location of the recording; was the user instructed not to record the interview; a list of every item seized from the user by the investigative agency; did the seizing investigator wear gloves; did seizing investigator place the evidence in an evidence container and seal it in the user's presence; and/or were pictures taken of the user by the investigative agency or anyone else.

Some embodiments provide that post incident investigation data includes: whether the user's blood drawn; if so, by whom, where, who was present, was submission of the sample by order; were documents signed at that time; and/or copies of signed document.

Some embodiments provide that post incident investigation data includes: whether the user's urine sample was gathered; if so, by whom, where, who was present, was submission of the sample by order; were documents signed at that time; and/or copies of signed document.

Coincident to the drawing of blood and/or urine, photos of search warrant, a consent document, a sealed bag and an evidence receipt, among others.

Post-incident investigation data further includes whether any data was gathered based on a search warrant or by consent and/or includes a copy of a search warrant.

Post-incident investigative data further includes data corresponding to items that were seized including a firearm, handgun, rifle, shotgun, magazine(s), taser, ASP baton, handcuffs, uniform shirt, uniform pants, utility belt, shoes/boots, and/or cellphone, among others. If a firearm was seized, data includes whether it was personal or issued and/or whether it was provided consensually or by search warrant, and whether it was in the exact same condition as it was at the end of the incident. If the condition was changed, data includes how it was changed, including being unloaded, chamber emptied, magazine replaced with a full magazine. Data further includes a stated reason for the change including one or more of officer safety and/or ordered to do so, among others.

Post-incident investigative data further includes the user's agency incident report number and the investigative agency case number.

In some embodiments, operations may include generating (516) a calendar entry that corresponds to planned activities that are related to the incident. Some embodiments provide that a link to a calendar is provided to input any relevant dates. Examples of such dates may include court dates for hearings, grand jury, preliminary motions, and/or trials, among others.

Operations may include providing (518) a prompt to a user to provide input indicating the custodial status of the wireless communication device. Based on the prompt, the wireless communication device may receive (520) input indicating the custodial status of the wireless communication device. For example, in some embodiments, the prompt may instruct the user to confirm that the application disclosed herein is not installed on a government phone or a phone paid for by a government entity. The prompt may further instruct that the information being gathered is not typically gathered following every arrest, incident, or encounter. The prompt may instruct the user to make certain that the information is being gathered in anticipation of litigation for the specific purpose of assisting an attorney in defending the user in a criminal or civil case. An agreement may be received before the application may be used.

Additionally, prior to using the application disclosed herein, the officer information and equipment must be completed. When prompted, add a photograph and/or weight of each piece of equipment. These will be integrated into an incident when needed.

For each incident where force was required, fill out each item as completely as possible. Once you go to the next item, the information cannot be edited. You will be able to add additional information at the conclusion of the questionnaire and at later dates. The information submitted is time stamped and dated.

Operations according to some embodiments include providing (522) a prompt for a user to provide an input that disclaims usage limitations. Operations may further include receiving (524) an input indicating that the usage limitations are acknowledged. Example limitation include that neither the methods disclosed herein nor creators thereof are providing or intending to provide legal advice. The usage limitations further direct the user to contact their legal advisor or attorney and that the methods herein only provide suggestions for investigative actions in anticipation of a defense for the user. Receipt of inputs acknowledging usage limitations may be necessary to use the methods disclosed herein.

Operations include providing (526) a prompt for the user to secure incident related documentation. Operations further include receiving (528) the incident related documentation and/or an input that confirms that the incident related documentation is secured. Incident related documentation may include whether it was a riot situation, how the dispatch was notified, was it a self-initiated activity, was information from another officer, how was presence made known to suspect, if verbal, notes regarding what was said, and the location type, such as, private property, public property, business, residence, street/highway, wooded area, field, lake, pond, river and/or ocean.

Embodiments herein may include a computer program product that includes a tangible computer readable storage medium comprising computer readable program code embodied in the medium that when executed by at least one processing circuit, causes the computer readable code to perform any of the operations corresponding to embodiments disclosed herein.

What is claimed is:

1. A method of operating a wireless communication device, comprising:
prior to use corresponding to incident, providing, via a user interface in the wireless communication device, a prompt for a user to provide law enforcement officer data, wherein law enforcement officer data comprises a jurisdiction state;
in responsive to receiving law enforcement officer data, displaying audio and/or video regulations corresponding to the jurisdiction state;
providing, via the user interface, a prompt for the user to provide equipment data that corresponds to equipment that is expected to be used by a law enforcement officer;
receiving, via a user interface, the equipment data;
responsive to receiving input that incident has occurred, receiving inputs from user that affirm safety conditions are satisfied;
providing, via the user interface, a prompt for the user to provide a plurality of types of incident data, wherein the plurality of types of incident data comprises at least two of scene data, utilized equipment data corresponding to equipment that was deployed corresponding to the incident, suspect action data, suspect physical characteristic data, building/structure data, additional equipment data, incident scene crowd data, officer credential data, and/or legal obligation data; and
receiving, via the user interface, at least two of the plurality of types of incident data.

2. The method of claim 1, further comprising generating a calendar entry that corresponds to planned activities that are related to the incident.

3. The method of claim 1, wherein the equipment data comprises images and/or a weight of each equipment item to be carried by the user.

4. The method of claim 1, wherein the equipment data corresponds to at least one of a weapon, a holster, ammunition, a personal restraint, a non-lethal weapon, a recording device, flashlight, communication equipment, protective clothing, and personal protective equipment.

5. The method of claim 1, wherein, before providing a prompt for incident related data, the method further comprises:
providing, via the user interface, a prompt to provide input indicating custodial status of the wireless communication device; and
receiving, via the user interface, an input indicating the custodial status of wireless communication device.

6. The method of claim 5, wherein, before providing a prompt for incident related data, the method further comprises:
providing, via the user interface, a prompt for the user to provide an input that disclaims usage limitations; and
receiving, via the user interface, an input indicating the usage limitations are acknowledged.

7. The method of claim 1, wherein the safety conditions comprise at least one of an input that confirms that threats are contained, an input that confirms that aid has been rendered to everyone and/or that medical personnel are rendering aid, an input that confirms that the user is approved by medical personnel to continue and/or an input that confirms that a suspect is restrained safely.

8. The method of claim 1, further comprising providing, via the user interface, a prompt for the user to secure incident related documentation.

9. The method of claim 8, further comprising receiving, via the user interface, the incident related documentation and/or an input that confirms that the incident related documentation is secured.

10. A computer program product, comprising:
a tangible computer readable storage medium comprising computer readable program code embodied in the medium that when executed by at least one processor causes the at least one processor to:
prior to use corresponding to incident, provide, via a user interface in the wireless communication device, a prompt for a user to provide law enforcement officer data, wherein law enforcement officer data comprises a jurisdiction state;
in responsive to receiving law enforcement officer data, display audio and/or video regulations corresponding to the jurisdiction state;
provide, via the user interface, a prompt for the user to provide equipment data that corresponds to equipment that is expected to be used by a law enforcement officer;
receive, via a user interface, the equipment data;
responsive to receiving input that incident has occurred, receive inputs from user that affirm safety conditions are satisfied;
provide, via the user interface, a prompt for the user to provide a plurality of types of incident data, wherein the plurality of types of incident data comprises at least two of scene data, utilized equipment data corresponding to equipment that was deployed corresponding to the incident, suspect action data, suspect physical characteristic data, building/structure data, additional equipment data, incident scene crowd data, officer credential data, and/or legal obligation data; and
receive, via the user interface, at least two of the plurality of types of incident data.

11. A wireless communication device comprising:
a processing circuit;
a user interface; and
a memory that includes machine-readable code that, when executed, cause the processing circuit to perform the following operations:
prior to use corresponding to incident, providing, via a user interface in the wireless communication device, a prompt for a user to provide law enforcement officer data, wherein law enforcement officer data comprises a jurisdiction state;
in responsive to receiving law enforcement officer data, displaying audio and/or video regulations corresponding to the jurisdiction state;
providing, via the user interface, a prompt for the user to provide equipment data that corresponds to equipment that is expected to be used by a law enforcement officer;
receiving, via a user interface, the equipment data;
responsive to receiving input that incident has occurred, receiving inputs from user that affirm safety conditions are satisfied;
providing, via the user interface, a prompt for the user to provide a plurality of types of incident data, wherein the plurality of types of incident data comprises at least two of scene data, utilized equipment data corresponding to equipment that was deployed corresponding to the incident, suspect action data, suspect physical characteristic data, building/structure data, additional equipment data, incident scene crowd data, officer credential data, and/or legal obligation data; and
receiving, via the user interface, at least two of the plurality of types of incident data.

12. The wireless communication device of claim 11, wherein the processing circuit is further caused to perform generating a calendar entry that corresponds to planned activities that are related to the incident.

13. The wireless communication device of claim 11, wherein the equipment data comprises images and/or a weight of each equipment item to be carried by the user.

14. The wireless communication device of claim 11, wherein the equipment data corresponds to at least one of a weapon, a holster, ammunition, a personal restraint, a non-lethal weapon, a recording device, flashlight, communication equipment, protective clothing, and personal protective equipment.

15. The wireless communication device of claim 11, wherein, before providing a prompt for incident related data, the processing circuit is further caused to perform:
providing, via the user interface, a prompt to provide input indicating custodial status of the wireless communication device; and
receiving, via the user interface, an input indicating the custodial status of wireless communication device status.

16. The wireless communication device of claim 15, wherein, before providing a prompt for incident related data, the wherein the processing circuit is further caused to perform:
providing, via the user interface, a prompt for the user to provide an input that disclaims usage limitations; and
receiving, via the user interface, an input indicating the usage limitations are acknowledged.

17. The wireless communication device of claim 16, wherein the safety conditions comprise at least one of an input that confirms that threats are contained, an input that confirms that aid has been rendered to everyone and/or that medical personnel are rendering aid, an input that confirms that the user is approved by medical personnel to continue and/or an input that confirms that a suspect is restrained safely.

18. The wireless communication device of claim 11, wherein the processing circuit is further caused to perform providing, via the user interface, a prompt for the user to secure incident related documentation.

19. The wireless communication device of claim 11, wherein the processing circuit is further caused to perform receiving, via the user interface, the incident related documentation and/or an input that confirms that the incident related documentation is secured.

20. The wireless communication device of claim 11, wherein the user interface comprises at least two of a keypad, a touch-sensitive screen, a display, a speaker, a microphone, a camera and am on-board power supply.
